(19) United States
(12) Patent Application Publication
(10) Pub. No.: US 2018/0161220 A1
(43) Pub. Date: Jun. 14, 2018

(54) AID ROBOT FOR TRANSPORTING

(71) Applicant: CUREXO, INC., Seoul (KR)

(72) Inventors: Hyunhwa HONG, Anyang-si (KR); Dongmyung MIN, Hwaseong-si (KR); Suncheol KWON, Seoul (KR)

(73) Assignee: CUREXO, INC., Seoul (KR)

(21) Appl. No.: 15/573,608

(22) PCT Filed: May 10, 2016
(86) PCT No.: PCT/KR2016/004897

§ 371 Date: Nov. 13, 2017

(30) Foreign Application Priority Data
May 12, 2015 (KR) 10-2015-0065909

(51) Int. Cl. A61G 5/04; A61G 5/10; A61G 5/12

(52) U.S. Cl. CPC A61G 5/04; A61G 5/1051; A61G 5/125; A61G 5/1056

(57) ABSTRACT

The aid robot for transporting according to the present invention comprises a driving portion driven electrically by operating a switch; an elevating portion which is coupled to the driving portion and of which a height is adjustable; and a weight support portion which is coupled to the elevating portion so that a tilt of the weight support portion is adjustable, and formed so that its width become narrower and then wider reversely towards the bottom to piggyback the user, wherein the weight support portion comprises a support part at the bottom where the user's bottom is seated, and a wing part at the top for supporting the user's armpits. According to the aid robot for transporting, the weight support portion has a structure that the user can be easily piggybacked thereby reducing time to seat on.

### BACKGROUND OF THE INVENTION

### 1. Field of the Invention

The present invention relates to an aid robot for transporting which includes a driving portion driven with switch operation, an elevating portion, and a weight support portion. The height of the elevating portion and the incline angle of the weight support portion are adjustable with switch operation in the state that the user is piggybacked comfortably on the weight support portion, and therefore the aid robot can transport the user easily.

### 2. Description of the Related Art

Elderly people or patients who are difficult to move themselves need helps from their guardian, nurse or care worker to go to anyplace. When their guardian or others helps the elderly people or patients to move, wheelchair is used generally. With wheelchair, excessive force while they move the elderly people or patients from bed to wheelchair results in some accident and some of the elderly people or patients would feel nervous or uncomfortable. Also, in hospital, the number of care workers is very insufficient compared to the demand.

To solve aforementioned problem, various patient transporting devices have been provided, but conventional patient transporting devices have robotic structure such like forklifts for moving the patient in a horizontal direction so as to make him feel like baggage negatively.

The transportation robot for nursing patients disclosed in Korean Patent number 10-1394896 has a structure that the patient seats on sling. While the patient tries to seat on the sling, there is a risk that the patient falls off, and the guardian or nurse experiences inconvenience to assist the patient to seat on the sling. Moreover, it takes a long time to seat the patient.

### SUMMARY OF THE INVENTION

An object of the present invention is to solve aforementioned problems. The present invention is to provide an aid robot for transporting which is able to minimize the burden of patient's guardian or nurse and transport the patient in short time and increase safeness of the patient.

The aid robot for transporting, which is for achieving this object, includes a driving portion driven electrically, an elevating portion which is coupled to the driving portion and whose height is adjustable, and a weight support portion which supports the weight of the patient and fixes the patient with comfortable piggyback. Thereby it can improve the transport method of the patient and increases the convenience.

In order to achieve the above object, according to an aid robot for transporting a user who is piggybacked on a driving portion driven electrically by operating a switch; an elevating portion which is coupled to the driving portion and of which a height is adjustable; and a weight support portion which is coupled to the elevating portion so that a tilt of the weight support portion is adjustable, and formed so that its width become narrower and then wider reversely towards the bottom to piggyback the user, wherein the weight support portion comprises a support part at the bottom where the user's bottom is seated, and a wing part at the top for supporting the user's armpits.

Preferably, the aid robot further includes a tilt adjustment portion which is connected between the elevating portion and the weight support portion so as to adjust the tilt angle of the weight support portion by operating the switch.

In addition, the driving portion has a groove in the shape of ⊂ which is formed on the rear of the driving portion, and the groove in the shape of ⊂ has the width that is wider than width of lower part of toilet bowls or width of wheelchairs.

Preferably, the aid robot further includes a patient fixing portion which is connected with each of both-side wing parts of the weight support portion to fix the user who is piggybacked on the aid robot.

And, the aid robot further includes a handle portion which is connected to the front of the weight support portion so as to support arms of the user.

Further, the aid robot further includes a wired or wireless operating unit placed on the handle portion for operating the switch.

The wired or wireless operating unit includes a joystick for operating the driving portion, a height adjustment switch for operating the elevating portion to adjust the height of the weight support portion, a tilt angle adjustment switch for operating the tilt adjustment portion to adjust the tilt angle of the weight support portion back and forth, and a brake switch for stopping the driving portion from driving in case of emergency.

Preferably, a support is stood on the driving portion to connect a ringer holder.

Moreover, decelerators and electric motors are installed on the front of the driving portion to be connected with each driving wheel respectively, and a control unit and a power unit are installed on the middle of the front of the driving unit, and casters are installed on both sides of a leg part in shape of ⊂ on the rear of the driving portion.

And, the aid robot further includes encoders connected with each of the electric motors respectively which is on the opposite side of each of the decelerators.

In addition, the aid robot further includes a caster installed on the bottom of the front of the driving portion.

Moreover, the aid robot further includes stoppers installed on the casters respectively which are on both sides of the leg part in the shape of ⊂.

Preferably, the driving portion has a gap below a certain height with the ground by the driving wheels and the casters.

And, the power unit includes a power on/off switch, a battery, a charging unit, and a cover of the charging unit.

Preferably, the aid robot further includes a remaining battery capacity display unit which is connected with the battery and installed on the driving portion.

According to the aid robot for transporting, the weight support portion has a structure that the user can be easily piggybacked thereby reducing time to seat on, and the implementation cost is reduced due to simplified structure of the weight support portion. Also, the weight support portion has the improved structure to seat comfortably, and it can reduce pressure from a belt and distribute the weight of the patient.

In addition, the aid robot for transporting can transport the piggybacked patient easily in short time with the driving portion driven electrically, and can reduce a radius of rotation by a wheel type drive method.

Further, according to the aid robot for transporting, the switch operations for controlling the driving portion and the weight support portion are performed through the operating unit in one control system, thereby providing higher convenience. Particularly, compared to electric wheelchairs or conventional patient transporting apparatus, according to the aid robot for transporting, the patient can move more easily from bed to toilet or wheelchair, thereby reducing the user's burden.

### BRIEF DESCRIPTION OF THE DRAWINGS

FIG. 1 is a frontal perspective view of the aid robot for transporting according to an embodiment of the present invention.

FIG. 2 is a rear perspective view of the aid robot for transporting according to an embodiment of the present invention.

FIG. 3 is a side view of the aid robot for transporting according to an embodiment of the present invention.

FIG. 4 is a perspective view of the driving portion of the aid robot for transporting according to an embodiment of the present invention.

FIG. 5 is a perspective view of the driving portion of the aid robot for transporting according to another embodiment of the present invention.

FIG. 6 is a structural view of the operating unit of the aid robot for transporting according to an embodiment of the present invention.

### DETAILED DESCRIPTION OF THE INVENTION

Hereinafter, exemplary embodiments of the aid robot for transporting according to the present invention will be described in detail referring to the appended drawings. The present invention is not limited to the embodiments that will be described below and can be implemented in multiple different ways. These embodiments are provided only to explain the present invention and to tell the scope of the invention to those of ordinary skill in the art.

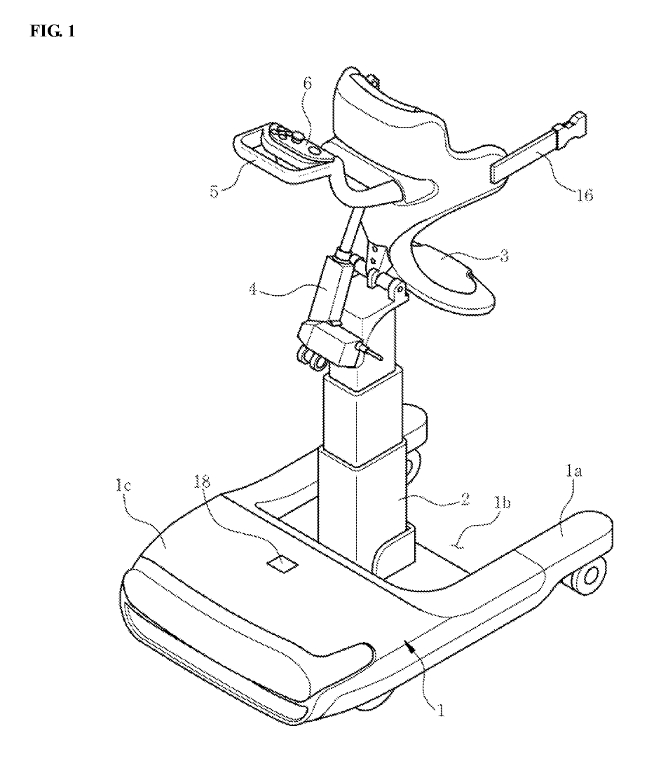

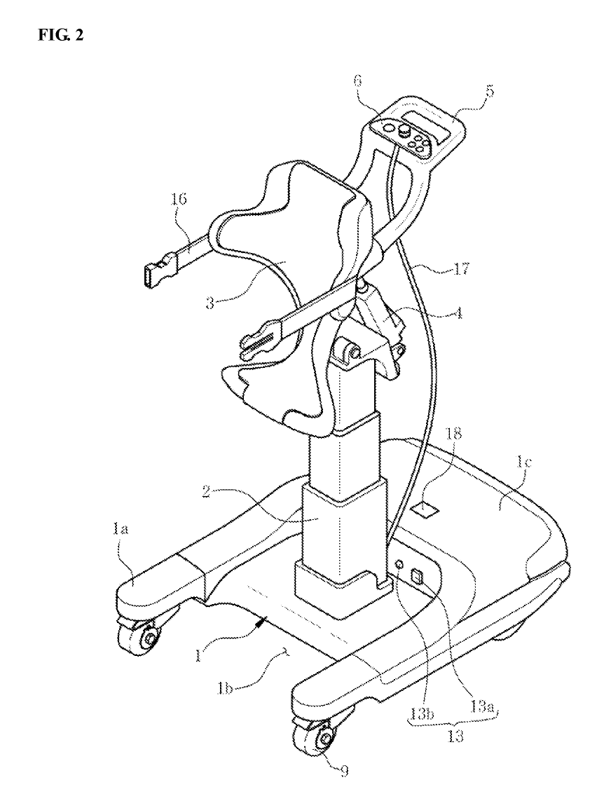

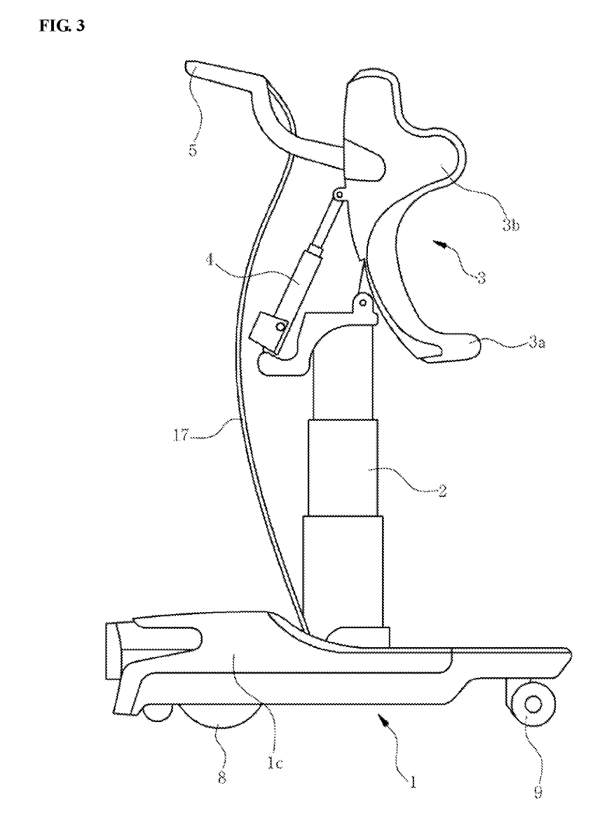

FIG. 1 is a frontal perspective view of the aid robot for transporting according to an embodiment of the present invention, FIG. 2 is a rear perspective view of the aid robot for transporting according to an embodiment of the present invention, and FIG. 3 is a side view of the aid robot for transporting according to an embodiment of the present invention.

As illustrated in FIG. 1, FIG. 2, and FIG. 3, the aid robot for transporting according to the present invention basically comprises a driving portion 1, an elevating portion 2, and a weight support portion 3. A tilt adjustment portion 4 is connected between the elevating portion 2 and the weight support portion 3 so as to adjust the tilt angle of the weight support portion 3. A handle portion 5 is connected with the weight support portion 3, and an operating unit 6 is placed on the handle portion 5.

The driving portion 1 is for driving on the ground with its wheels. The rear both ends of the driving portion 1 have a lengthened leg part 1a so as to form a groove 1b in the shape of ⊂ on the rear. Each driving wheel 8 is installed on the both sides of the frontal tip of the driving portion 1 respectively. The each driving wheel 8 is connected with electric motor 7. Casters 9 are installed on both ends of the leg part 1a.

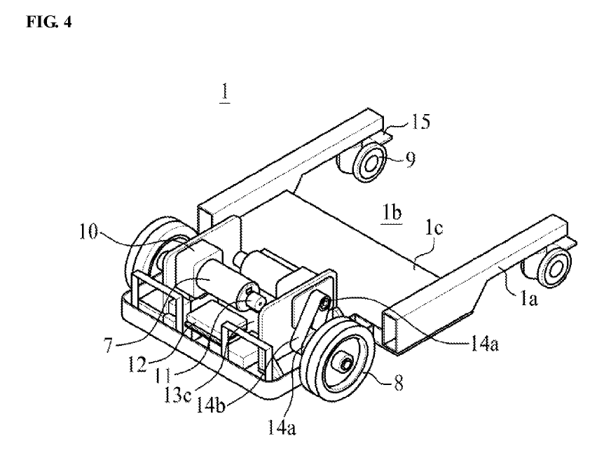

The detailed structure of the driving portion 1 is described below referring to FIG. 4.

FIG. 4 is a perspective view of the driving portion of the aid robot for transporting according to an embodiment of the present invention.

Referring to FIG. 4, the driving portion 1 has a frame 1c. The rear both sides of the frame 1c of the driving portion 1 are connected with the leg part 1a. The driving portion 1 includes the driving wheels 8 placed on the frontal both sides of the driving portion 1, the casters 9 placed on the rear both sides of the driving portion 1, and other components. The other components include electric motors 7, decelerators 10, encoders 11, a control unit 12, and a power unit 13, and are installed on the front of inside the frame 1c.

As explaining specifically, the electric motors 7 are installed respectively on both sides inside the frame 1c of the driving portion 1. The each decelerator 10 is connected with the exterior motor shaft of the each electric motor 7. A pulley 14a and a driving belt 14b are connected between the motor shaft which is protruded due to connection with the decelerator 10 and the axis of the driving wheel 8. The each encoder 11 is connected with the interior motor shaft of the each electric motor 7 to increase straightness by controlling the speed. And the control unit 12 and the power unit 13 are installed side by side on the middle of the front in the frame 1c. The control unit 12 controls the drive of the driving portion 1, elevating operation of the elevating portion 2, and the tilt angle of the weight support portion 3. The other caster can be installed on the beneath of the control unit 12 so as to assist the driving portion 1 to cross easily some protrusions or raised spots on the ground. In reference, the other caster has not been shown in figure.

A stopper 15 operated by pressing with foot is installed on the caster 9 placed on the leg part 1a of the driving portion 1. The stopper 15 has a brake function to stop casters 9 from driving as necessary. The interior width of the groove 1b in the shape of ⊂ formed on the rear of the driving portion 1 is wider than width of lower part of toilet bowls or width of wheelchairs. Accordingly, it can provide enough space so that the lower part of toilet bowls or wheelchairs can get into the rear of the driving portion 1.

It is preferable that the bottom of the driving portion 1 maintains suitable height from the ground, for example, the height of about under 20 cm. This is because it is preferable that the driving portion 1 gets into the beneath of the guardian's bed so that the aid robot for transporting approaches as close as possible to the guardian's bed, considering the aid robot for transporting is usually used in hospital room when transporting the patient with piggyback.

The elevating portion 2 can be coupled to the driving portion 1 by a bottom support. The elevating portion 2 is coupled to the rear of the frame 1c of the driving portion 1 where the electric motors 7 and the decelerators 10 are placed. The elevating portion 2 can be coupled to the driving portion 1 in a vertical direction perpendicular to the drive direction of the driving portion 1. However, the coupling direction is not limited, and the elevating portion 2 can be coupled in other directions to the driving portion 1 as long as the elevating portion 2 can support and elevate the weight support portion 3 and the user. The elevating portion 2 is formed in the shape of a hydraulic cylinder or electric cylinder. The cylinder is formed as a box type cylinder that the smaller box shaped cylinder bodies are inserted in series into the big box shaped cylinder body, like an antenna. Accordingly, like the antenna, when the small cylinder bodies come out continuously by the elevating portion 2, the height of the cylinder gets higher. On the contrary, when the small cylinder bodies go inside continuously by the elevating portion 2, the height of the cylinder gets lower. In this way, the elevating portion 2 moves up and down.

The weight support portion 3 is coupled to the elevating portion 2 so as to incline towards the rear of the driving portion 1. The upper area just above the bottom of the weight support portion 3 has narrow width. With this narrow width of the upper area as reference, the width of the weight support portion 3 becomes a lot wider towards the top and becomes slightly wider towards the bottom. And the weight support portion 3 has a shape of upward curve. This upward curve of the bottom of the weight support portion 3 forms a support part 3a where the user's bottom is seated. And at the both sides of the top which has wide width, a wing part 3b is formed. The wing part 3b is protruded towards the rear of the driving portion 1. An interior support frame, sponge for weight distribution, and exterior of the weight support portion 3 are preferable to be covered with leather according to the shape of the weight support portion 3.

The reason why the upper area just above the bottom of the weight support portion 3 has narrow width is because it is formed to be easily inserted between the user's legs when the user is piggybacked on the weight support portion 3. And the wide width of the top is for supporting the upper body of the user stably. Further, the shape of the upward curve of the support part 3a is to prevent the user's bottom from falling back after the user is seated. And the user leans against the upper part of the weight support portion 3 and the user's armpits are put on the wing part 3b comfortably. As a result, the weight support portion 3 has a shape that the user can be piggybacked comfortably.

The tilt adjustment portion 4, which is implemented with a hydraulic cylinder or electric cylinder, is connected slantingly between the frontal upper part of the elevating portion 2 and the rear of the weight support portion 3. So, the tilted angle of the weight support portion 3 related to the amount of incline forward or backward is adjusted properly by operation of the tilt adjustment portion 4. As the tilt adjustment portion 4 is operated, the length of the tilt adjustment portion 4 is varied and the tilt angle of the weight support portion 3 is adjusted properly along the variation of the length. Between the elevating portion 2 and the weight support portion 3 and between the tilt adjustment portion 4 and the weight support portion 3 are connected by components such as joint link, or hinge pin, etc.

The operations of electric motors 7 of the driving portion 1, the elevating portion 3, and the tilt adjustment portion 4 are controlled systematically by the control unit 12. And the operation power is provided by the power unit 13 including a battery 13c.

The wing part 3b on the both sides of the weight support portion 3 is connected with a belt of which the length is adjustable according to the body shape of the user, such as Velcro or buckle. The belt is functioned as a patient fixing portion 16 for fixing the back of the user who is piggybacked on the weight support portion 3 by covering with the belt.

The rear upper part of the weight support portion 3 is connected with the handle portion 5 which is in the shape of frame protruded backwards. The guardian or the nurse can move manually the aid robot for transporting with holding the handle portion 5. The handle portion 5 can be also used for supporting the user's arm when the user tries to get on the weight support portion 3. The operating unit 6, which is for operating of the driving portion 1, the elevating portion 2 and the tilt adjustment portion 4, is placed on the flat area at the tip of the handle portion 5.

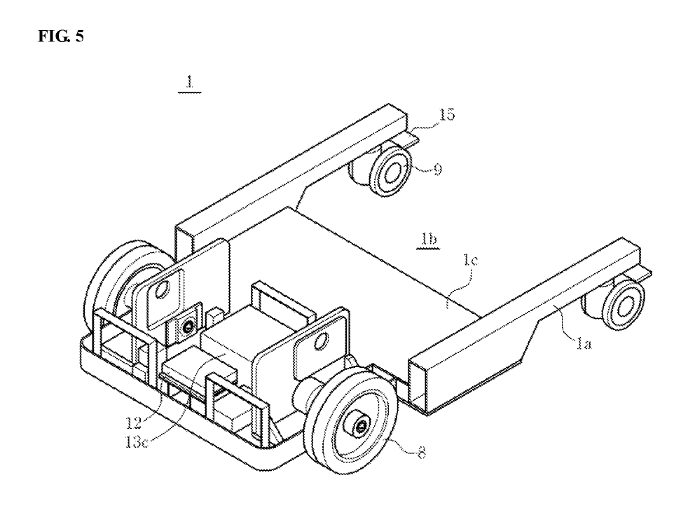

FIG. 5 is a perspective view of the driving portion 1 of the aid robot for transporting according to another embodiment of the present invention.

As illustrated in FIG. 5, the driving portion 1 of the aid robot for transporting can drive by only the driving wheels 8 and the casters 9 without the components for driving electrically, such as the electric motors 7, the decelerators 10, the pulley 14a, or the driving belt 14b. In this case, the guardian or nurse holds the aid robot directly and move the aid robot without any switch operation.

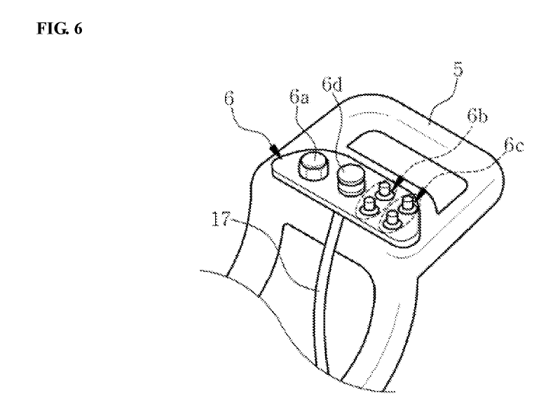

FIG. 6 is a structural view of the operating unit 6 of the aid robot for transporting according to an embodiment of the present invention.

As illustrated in FIG. 6, the operating unit 6 includes a joystick 6a having steering function for operating the driving portion 1, a height adjustment switch 6b for operating the box type cylinder of the elevating portion 2 to adjust the height of the weight support portion 3, a tilt angle adjustment switch 6c for operating the cylinder of the tilt angle adjustment portion 4 to adjust the tilted angle of the weight support portion 3 back and forth, and a brake switch 6d for stopping the aid robot for transporting from driving in case of emergency. The brake switch 6d is used for braking or stopping urgently the driving wheels 8. When the operating unit 6 communicates through wired communication, the operating unit 6 is connected to the control unit 12 by a power supply line 17 illustrated in FIG. 6. On the other hand, when the operating unit 6 communicates through wireless communication, the operating unit 6 is used as remote controller.

The power unit 13 includes an internal battery 13c, a power on/off switch 13b, a charging unit, and a cover 13a of the charging unit. The operator such as nurse turns on or off the aid robot by the power on/off switch 13b. The charging unit is connected with a charging connector for charging the battery 13c of the aid robot. And the cover 13a protects the charging unit from foreign substances.

The frame 1c of the driving portion 1 can further include a remaining battery capacity display unit 18 connected with the battery 13c of the power unit 13. The remaining battery capacity can be checked by the remaining level displayed on the remaining battery capacity display unit 18.

The charging connector is used for charging the battery 13c of the power unit 13. Because this kind of charging connector is general in technical field, the detailed explanation about the charging connector is omitted.

Although the invention has been shown and described with reference to certain exemplary embodiments thereof, the present invention is not limited by the embodiments described above. The various modifications can be made based on the described embodiments and the illustrated figures by those skilled in the art without departing from the spirit and scope of the invention as defined by the appended claims.

What is claimed is:

1. An aid robot for transporting a user who is piggybacked on, comprising:
a driving portion driven electrically by operating a switch;
an elevating portion which is coupled to the driving portion and of which a height is adjustable; and
a weight support portion which is coupled to the elevating portion so that a tilt of the weight support portion is adjustable, and formed so that its width become narrower and then wider reversely towards the bottom to piggyback the user,
wherein the weight support portion comprises a support part at the bottom where the user's bottom is seated, and a wing part at the top for supporting the user's armpits.

2. The aid robot according to claim 1, further comprising a tilt adjustment portion which is connected between the elevating portion and the weight support portion so as to adjust the tilt angle of the weight support portion by operating the switch.

3. The aid robot according to claim 1,
wherein the driving portion has a groove in the shape of ⊂ which is formed on the rear of the driving portion, and
wherein the groove in the shape of ⊂ has the width that is wider than width of lower part of toilet bowls or width of wheelchairs.

4. The aid robot according to claim 1, further comprising a patient fixing portion which is connected with each of both-side wing parts of the weight support portion to fix the user who is piggybacked on the aid robot.

5. The aid robot according to claim 1, further comprising a handle portion which is connected to the front of the weight support portion so as to support arms of the user.

6. The aid robot according to claim 5, further comprising a wired or wireless operating unit placed on the handle portion for operating the switch.

7. The aid robot according to claim 6,
wherein the wired or wireless operating unit comprises,
a joystick for operating the driving portion,
a height adjustment switch for operating the elevating portion to adjust the height of the weight support portion,
a tilt angle adjustment switch for operating the tilt adjustment portion to adjust the tilt angle of the weight support portion back and forth, and
a brake switch for stopping the driving portion from driving in case of emergency.

8. The aid robot according to claim 1,
wherein a support is stood on the driving portion to connect a ringer holder.

9. The aid robot according to claim 1,
wherein decelerators and electric motors are installed on the front of the driving portion to be connected with each driving wheel respectively, and
wherein a control unit and a power unit are installed on the middle of the front of the driving unit, and
wherein casters are installed on both sides of a leg part in shape of ⊂ on the rear of the driving portion.

10. The aid robot according to claim 9, further comprising encoders connected with each of the electric motors respectively which is on the opposite side of each of the decelerators.

11. The aid robot according to claim 9, further comprising a caster installed on the bottom of the front of the driving portion.

12. The aid robot according to claim 9, further comprising stoppers installed on the casters respectively which are on both sides of the leg part in the shape of ⊂.

13. The aid robot according to claim 9,
wherein the driving portion has a gap below a certain height with the ground by the driving wheels and the casters.

14. The aid robot according to claim 9,
wherein the power unit includes a power on/off switch, a battery, a charging unit, and a cover of the charging unit.

15. The aid robot according to claim 14, further comprising a remaining battery capacity display unit which is connected with the battery and installed on the driving portion.
